(19) United States
(12) Patent Application Publication
(10) Pub. No.: US 2014/0141953 A1
(43) Pub. Date: May 22, 2014

(54) Single pass printing of mailer envelopes and contents

(71) Applicant: Denise Hindle, Conyers, GA (US)

(72) Inventor: Denise Hindle, Conyers, GA (US)

(21) Appl. No.: 13/681,033

(22) Filed: Nov. 19, 2012

(51) Int. Cl. B31B 19/14; B31B 19/26; B31B 19/88

(52) U.S. Cl. CPC B31B 19/14; B31B 19/88; B31B 19/26
USPC 493/188; 493/216; 493/227; 493/323

(57) ABSTRACT

A method for single pass printing of mailer envelopes and contents includes: providing an envelope with an open window in the envelope; inserting a sheet into the envelope having an unprinted region so that the unprinted region is exposed through the window of the envelope; feeding the envelope into a printer; and printing a first customer-specific data (such as an address) on the envelope and a second customer-specific data (such as a barcode) on the exposed region of the sheet. The printer may be an inkjet printer so that the data is printed in a single pass, without removing the envelope from the printer.

### RELATED APPLICATIONS

This application claims the benefit of the filing date of U.S. Patent Application No. 61/561,554, filed Nov. 18, 2012, which is incorporated herein by reference in its entirety.

### BACKGROUND OF THE INVENTION

The present invention generally relates to printing of mailer envelopes and their contents and more specifically to a single pass ink jet addressing and bar coding of survey mailers through die cut window wrapper.

Currently, mailed documents cannot be made to guarantee that both the inner return data sheets and the outer wrapper (such as a self mailer) are printed with identical information in a single pass application. Current methods rely on slowing down the inserting process to verify the address on the letter and the member id on the survey are an exact match.

The current process of physically inserting previously addressed, individually processed inner return survey pieces with a matching letter of instructions into a conventional window mailing envelope relies upon perfect matching of all internal pieces. If there is a machine malfunction or jam they are not in the same sequence.

It would be desirable to utilize a single pass to provide ink jet addressing and bar coding of survey mailers through a die cut window wrapper.

### SUMMARY OF THE INVENTION

In one aspect of the present invention, a method of preparing a mailer includes providing an envelope with an open window in the envelope; inserting a sheet into the envelope having an unprinted region so that the unprinted region is exposed through the window of the envelope; feeding the envelope into a printer; and printing a first customer-specific data on the envelope and a second customer-specific data on the exposed region of the sheet.

In another aspect of the present invention, a method of addressing a mailer includes cutting a window into a mailer wrapper; including an internal document inside the mailer wrapper; and in a single pass, printing a first customer identification information upon the mailer wrapper and printing a second customer identification that corresponds to said first customer identification information upon the internal document through the window.

### BRIEF DESCRIPTION OF THE DRAWINGS

FIG. 1A depicts an embodiment of a mailer sheet according to the present invention;

FIG. 1B depicts the embodiment of a mailer sheet of FIG. 1A with a window;

FIG. 2 depicts the embodiment of a mailer sheet of FIG. 1A with a window and additional printing;

FIG. 3 depicts an embodiment of an internal sheet according to the present invention;

FIG. 4 depicts an embodiment of a mailer utilizing the mailer sheet of FIG. 2 and the internal sheet of FIG. 3;

FIG. 5 depicts the embodiment of a mailer of FIG. 4 secured with mailing tabs;

FIG. 6 depicts the embodiment of a mailer of FIG. 4 after single-pass printing;

FIGS. 7A, 7B and 7C depict an alternate embodiment of the present invention; and

FIG. 8 is a flowchart of an embodiment of the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

The present invention relates to a single pass ink jet addressing and bar coding of survey mailers through die cut window wrapper.

Embodiments of the present invention may verify and confirm that the outside addressed cover letter matches or corresponds to the unique member ID number or other customer-specific data on the included survey instrument. The two fields are printed generally simultaneously, in that the printer prints each envelope-and-sheet, after having already been assembled, without either being removed from the printer. Both the envelope and sheet are printed with customer-specific data in a single pass, without needing to feed the paper into a printer a second time for customer-specific data. Substantially all mechanical processing of data sheets, including printing, collating, stitching of multiple data sheets, folding and securing with United States Postal Service (USPS) approved clear mailing tabs, may be completed without any need to insure sequencing of matching pre-addressed, pre bar coded information. At the final stage of the survey mailing process, both the inside data sheet and the outer mailer may be ink jet addressed simultaneously. The matching data may be inkjet sprayed in a single pass both on the outside mail wrapper and through the die cut cover window onto the exposed inner survey or other individually-identified sheet of paper. This technique may be used as a self mailer or inserted into window envelopes. Embodiments of a finished mail piece may include a business reply mailer with a roll fold that is glued or inserted separately. A corresponding matching bar code printed through a physically open die-cut window in the outer mailer piece may assure matching of contents with outer mailer address data, and may provide for efficient and quick mail preparation. The matching bar code may provide a unique identifier for each mailing recipient, such as the entries in a database of customer mailing labels.

Embodiments of a mailer may include a die cut window. This exposes the inside sheets so that the ink can be sprayed on it without it being opened. The mailer panel may also be available to provide for addressing. The size of the mailer may vary according to USPS regulations. The business reply envelope may be for purposes of return survey info, if necessary. Embodiment may include self sealing edges for better USPS processing.

An embodiment of a process may provide that all non unique addressing operations be performed prior to utilizing the die cut window to ink jet apply the data field simultaneously to the outer and inner sheets in one pass. This process may allow the enclosed sheet to be exposed to inkjet variable information. This same mailer can be done in any shape, size, with or without an envelope. Embodiments may include a process of die cutting a window to expose the inside sheet for bar-coding. Embodiments may have the die cut window exposed on the back panel and use an inline upside down inkjet system.

In an embodiment, preparing the die cut window mailer can take various kinds of printing, copying, folding, perforating, inserting samples or return mailers to make up the finished inside mailer. Regardless of the contents, embodiment of an outer wrapper may have a die cut window to expose the inside sheet for inkjet.

Embodiments of the invention can be made utilizing an inkjet printer.

In an embodiment, documented, 100% accurate matching of internal item identification with outer wrapper could be adapted to serve other functions. If a manufacturer wanted to issue a warranty on their product, i.e. an automobile, refrigerator or some other type of consumer product, the same multiple window technique could be utilized to assure that the product action on warranty was performed as was specified in the warranty information packet. Items like oil changes, lubrication of chassis, fluid and or consumable hoses, tires, batteries, or any conceivable warrantable action would have a predated, pre addressed, pre bar coded must be adhered to sequence of performing.

Embodiments may apply to a printed, distributed document requiring both outer and inner identical data fields, applied simultaneously.

In embodiments, addressing through a die cut window may guarantee that both the inner return data sheet(s) and the outer wrapper (self mailer) are ink jet printed with identical information in a single pass application.

In embodiments, by addressing and bar coding through the die cut opening it is the final operation and no additional operations are necessary. The possibility of missed matched content and outer mailing address may be completely eliminated.

Embodiments may include a single pass ink jet addressing and bar coding of survey mailers through die cut window wrapper.

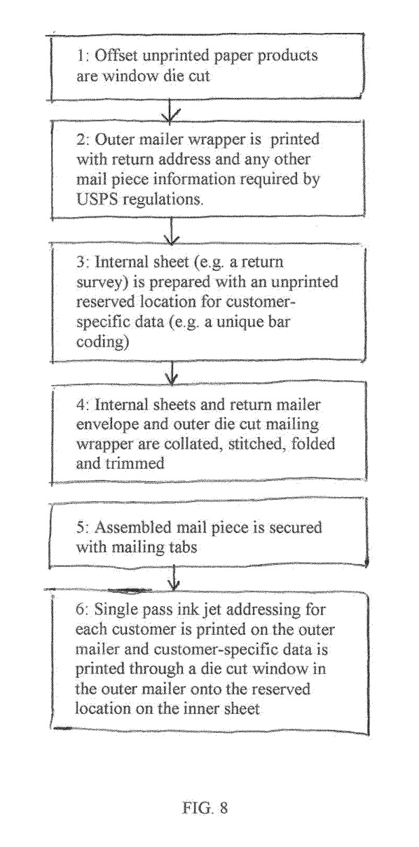

As depicted in the flowchart of FIG. 8, embodiments of the device or method may perform a series of steps. The invention itself may be the method, or the invention may also include apparatus and products that have structures to perform the steps. Unless specifically so stated, the steps do not necessarily need to be performed in the order listed.

In step 1 (FIG. 8, #1), a sheet of unprinted offset paper is provided, which will become the outer mailer or envelope, and a window is die cut into the sheet.

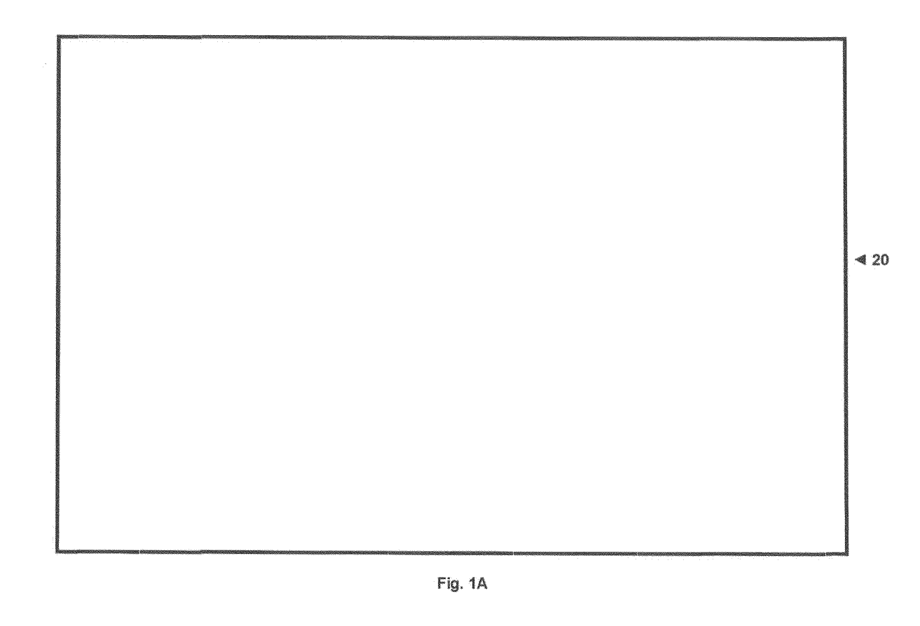

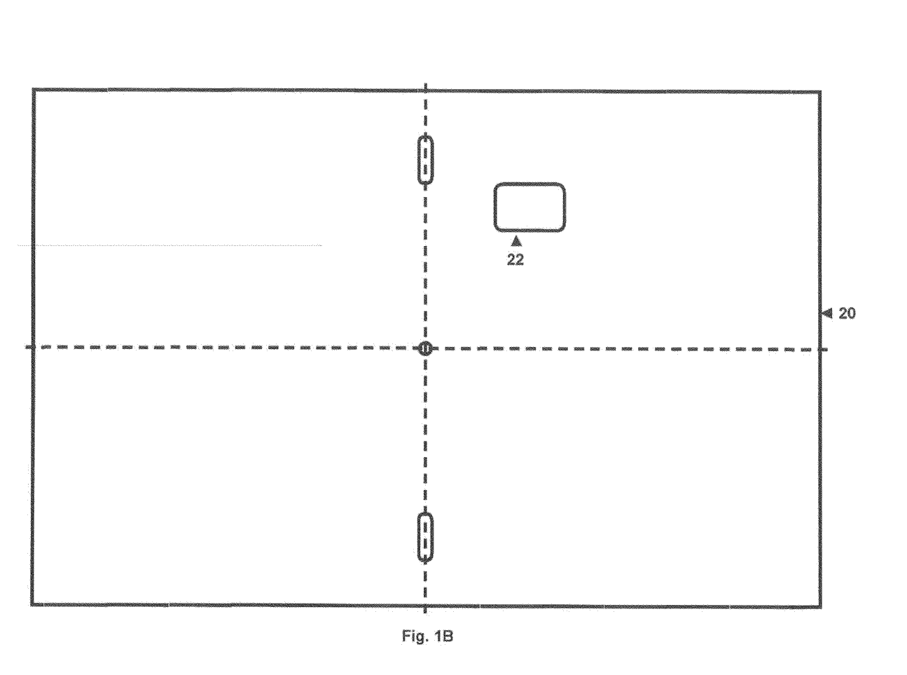

FIG. 1A depicts an outside view of an embodiment of a mailer sheet 20. An example sheet 20 for an outer mailer could be an 11″×17″ sheet of 60 lb offset paper, but size and weight may vary.

FIG. 1B depicts an embodiment of mailer sheet 20 with a die cut window 22. Offset unprinted paper products such as mailer sheet 20 may be window die cut (#22) prior to the survey print process, or the window may be formed by some other process. In some cases, possibly due to time restraints, the window location on the envelope may vary from a standard location, depending on the required location of the inner return survey barcode location. Additional die cuts may be made along the fold lines, to assist with handling of the mailer. The actual size of an example window 22 could be, for example, 1″×3½″ with rounded corners, but may vary depending on customer needs and USPS regulations. The final window location may be on the same surface as the completed mailer address. In other embodiments, the window 22 may be die cut after the offset printing process or other processes performed on the mailer sheet 20.

In step 2 (FIG. 8, #2), outer mailer sheet 20 may be printed on the front side with an outer upper front mailer text 24. Outer mailer sheet 20 may also be printed on the front side with outer lower front mailer text 26, which will become the back of the envelope when sheet 20 is folded, and (on the front side) with outer back text 28, which will become the inside of the envelope when folded. The mailer text may include alphanumeric text, or may also include art or other symbols. Mailer sheet 20 may be printed along with the internal sheets, or may be partially pre-printed.

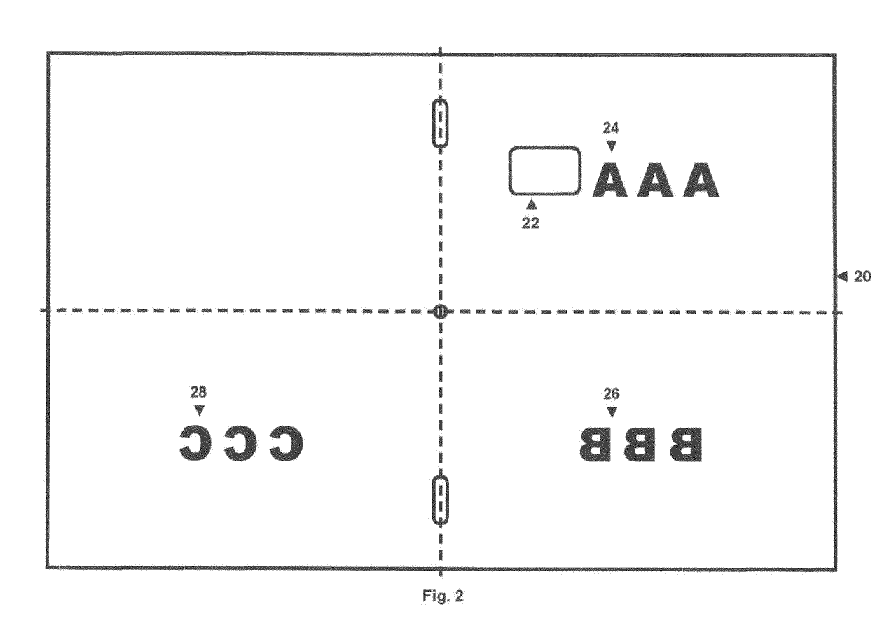

As depicted in FIG. 2, embodiments of an outer mailer sheet 20 may be folded to become an envelope having at least 3 portions of text. Outer upper front mailer text 24 becomes the front of the envelope when outer mailer sheet 20 is folded, and may include a return address and any other mail piece information required by USPS regulations. Postage may be applied either before or after printing. Outer lower front mailer text 26 becomes the back of the envelope when folded, so this text would be oriented upside-down relative to the front of the envelope. Outer back text 28 will be on the inside of the outer die cut wrapper, and may include customer's survey completion instructions.

In step 3 (FIG. 8, #3), an internal sheet 30 is prepared and printed to have a reserved location 32 for the as-yet unprinted unique bar coding. The reserved location 32 on the internal sheet 30 will align with the window 22 in the outer mailer sheet 20.

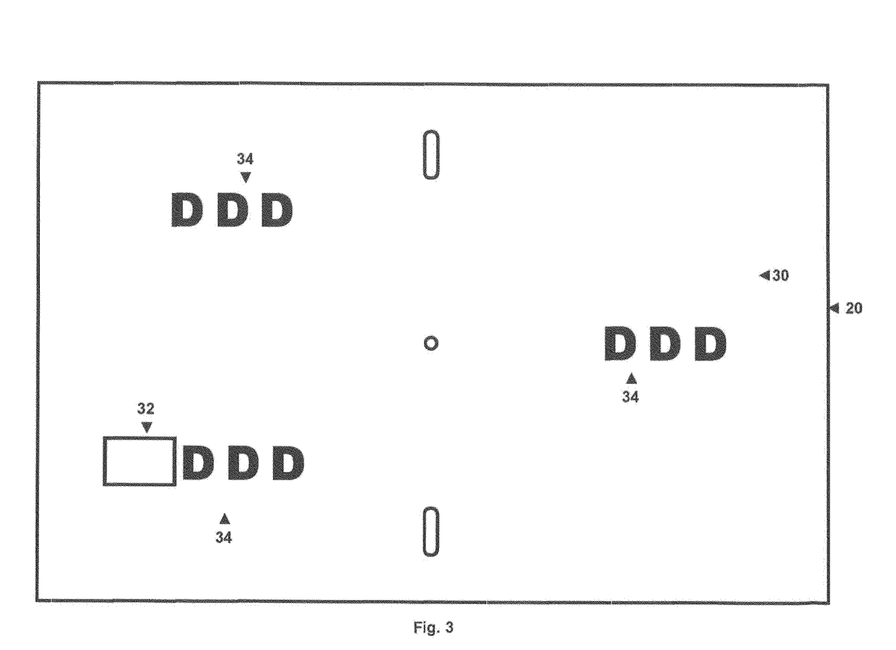

As depicted in FIG. 3, internal sheet 30 is prepared and printed with literature 34 to have an unprinted reserved location 32 for the unique bar coding or other customer-specific data. The front or back or both of the internal sheet 30 may include pre-printed literature 34, such as customer survey or brochure information which is to be mailed. The outside surface of the internal sheet 30, such as a return survey, may have a reserved location 32 for the unprinted unique bar coding or other customer-specific data. When the internal sheet 30 is folded and placed in the envelope, the unprinted reserved location 32 should align with the window 22 of the mailer sheet 20. Customer-specific data may be applied after further finishing operations have been completed to the entire mailer/survey piece. The back of internal sheet 30 may also contain printed material.

In step 4 (FIG. 8, #4), all printed internal sheets 30 along with a return mailer envelope and the outer die cut mailing wrapper 20 may be collated, stitched, folded and trimmed.

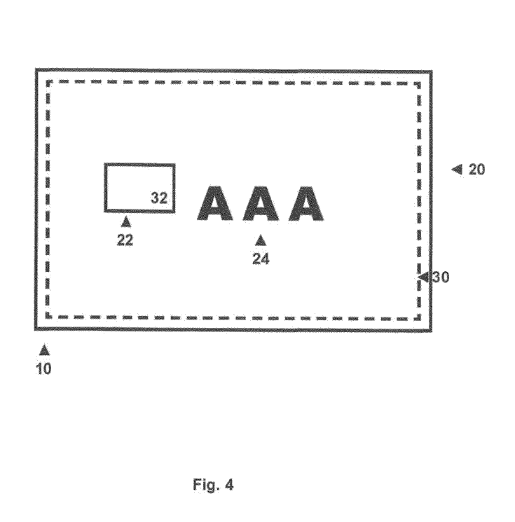

FIG. 4 depicts an embodiment of a mailer 10 ready to be single-pass printed. Outer mailer sheet 20 forms an envelope that contains internal sheet 30 and any other internal contents such as additional internal sheets or a return mailer envelope. The reserved location 32 on the internal sheet 30 is exposed and visible through the window 22 in the mailer sheet 20, so that the entire mailer 10 may be passed through an ink-jet printer and printed in a single pass without removing from the printer.

In step 5 (FIG. 8, #5) the assembled mailer may be secured with mailing tabs 36 in accordance with USPS requirements, or inserted into an outgoing envelope.

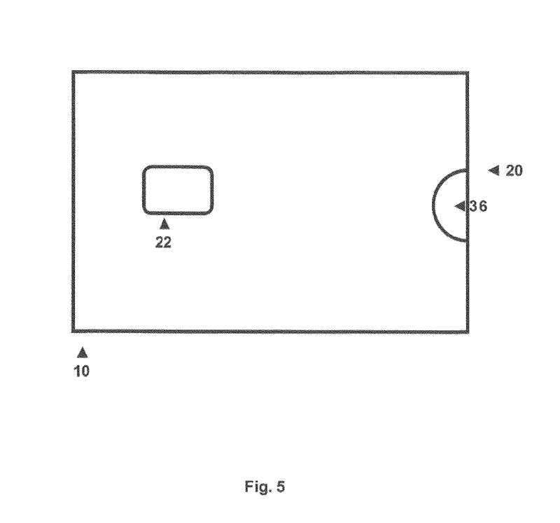

FIG. 5 depicts an embodiment of a USPS approved transparent mailing tab 36, applied to the mailer sheet 20 to seal the envelope.

In step 6 (FIG. 8, #6), once the mailer has been fully assemble and secured for mailing, the final unique single pass, ink jet addressing from the customer mailing file may be administered to the outer mailer and through the die cut window in the outer mailer onto the inner survey data sheets.

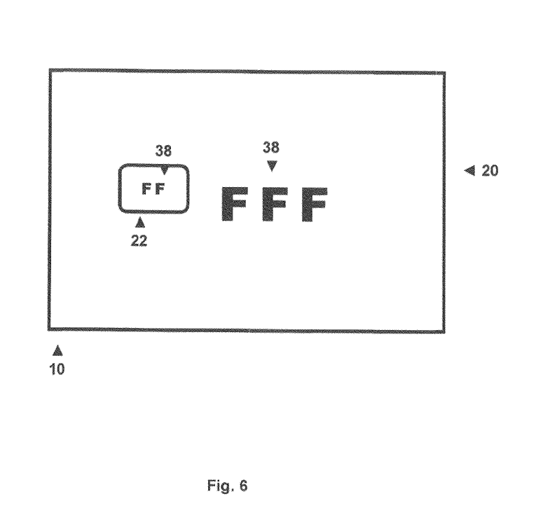

FIG. 6 depicts an embodiment of a finished mailer 10. Both the address information on the outer mailer 36 and the bar code or other customer specific data 38 is printed on the inner mailer through the die cut window 22, it is assured that the customer-specific information on the outer mailer and internal sheet will match.

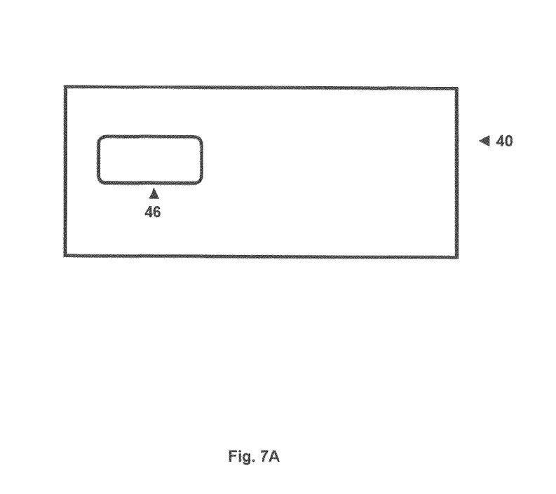

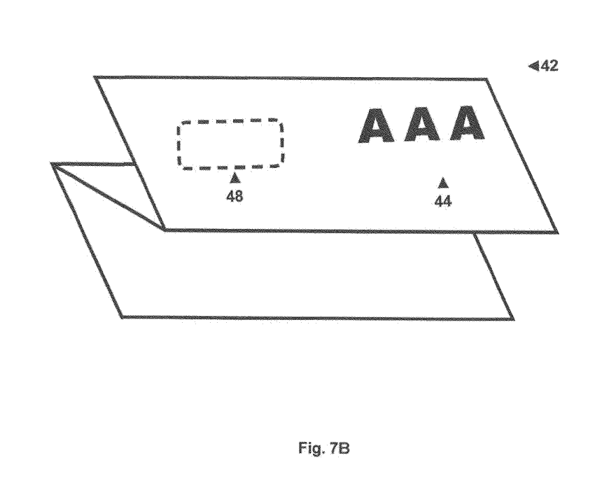

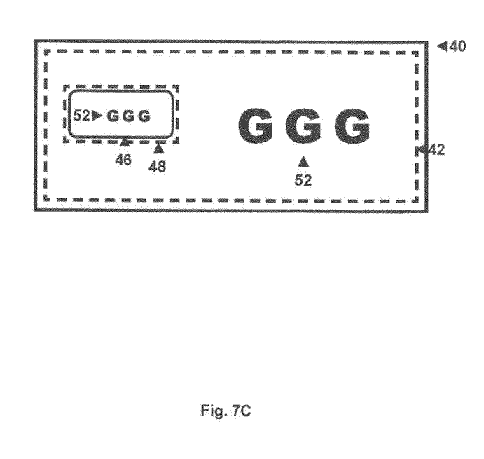

FIG. 7A depicts an embodiment of an envelope 40 and FIG. 7B depicts an internal sheet 42 with pre-printed material 44. The envelope 40 has a window 46 and internal sheet 42 has an unprinted reserved location 48 so that, when internal sheet 42 is folded and placed in the envelope 40, the window 46 and the reserved location 48 line up. FIG. 7C depicts a finished mailer 50. Customer-specific information 52 has been applied to both the envelope 40 and the internal sheet 42 in a single pass.

Embodiments may include a method of addressing a mailer, comprising: cutting a window into a mailer wrapper; including an internal document inside the mailer wrapper; and, in a single pass, printing address information upon the mailer wrapper and printing identification data that corresponds to said address information upon the internal document through the window.

I claim:

1. A method of preparing a mailer, comprising:
providing an envelope with an open window in the envelope;
inserting a sheet into the envelope having an unprinted region so that the unprinted region is exposed through the window of the envelope;
feeding the envelope into a printer; and
printing a first customer-specific data on the envelope and a second customer-specific data on the exposed region of the sheet.

2. The method of claim 1, wherein the envelope is fed through an inkjet printer, and the printer sprays ink onto the outside of the envelope and through the window onto the exposed region of the sheet.

3. The method of claim 1, wherein the first and second customer-specific data are printed generally simultaneously.

4. The method of claim 1, wherein the first customer-specific data and the second customer-specific data are printed in a single pass, without removing the envelope from the printer.

5. The method of claim 1, wherein the envelope is a second sheet that is die cut to provide the open window, folded, and tabbed to provide a container for the first sheet.

6. The method of claim 1, wherein the sheet and the envelope are sheets of paper and the first and second customer-specific data are applied by an inkjet printer onto the sheets of paper.

7. The method of claim 1, wherein for each customer in a list of customers, both an envelope and a corresponding inserted sheet are printed with data that is specific to each said customer.

8. The method of claim 1, wherein the first customer-specific data includes an address of a customer and the second customer-specific data includes a bar code that identifies the customer.

9. A method of addressing a mailer, comprising:
cutting a window into a mailer wrapper;
including an internal document inside the mailer wrapper; and
in a single pass, printing a first customer identification information upon the mailer wrapper and printing a second customer identification that corresponds to said first customer identification information upon the internal document through the window.

10. The method of claim 9, wherein the first customer identification information includes an address of a customer and the second customer identification information includes a barcode that identifies the customer.
